(19) United States
(12) Patent Application Publication
(10) Pub. No.: US 2018/0336537 A1
(43) Pub. Date: Nov. 22, 2018

(54) VEHICLE REGISTRATION SYSTEMS AND METHODS WITH DIGITAL REGISTRATION DISPLAY

(71) Applicant: MasterCard International Incorporated, Purchase, NY (US)

(72) Inventor: Pia Maenpaa, White Plains, NY (US)

(21) Appl. No.: 15/596,838

(22) Filed: May 16, 2017

(51) Int. Cl. G06Q 20/10; G06F 3/0481

(52) U.S. Cl. CPC G06Q 20/102; G06Q 40/08; G06F 3/0481

(57) ABSTRACT

A vehicle registration system includes at least one device configured to generate a vehicle registration data packet, and a vehicle including a vehicle device receiving the vehicle registration data packet. A vehicle display is in communication with the vehicle device and generating, in response to the vehicle registration data packet, an electronic proof of registration display at a designated location on the vehicle.

### BACKGROUND

This disclosure relates generally to the registration of vehicles with applicable registration authorities and accepting payment of registration fees, and more specifically to systems and methods for registering vehicles having integrated registration and digital display of proof of registration and facilitating registration fee payments.

Vehicles are in most cases required to be registered by their owners with governmental authorities in order for the vehicles to be lawfully operated. As typically administered, the vehicle registration process requires a series of manually performed tasks performed by different parties at various locations to verify compliance with the requirements as the time of initial registration or renewal.

Aside from being generally inefficient and inconvenient, numerous opportunities for confusion and mistake are presented that may lead to delay in applying for registration by a vehicle owner, delay in issuance of a vehicle registration or renewal by the registration authority, and/or delay in the proper display of current proof of registration by the owner. More efficient and convenient systems and processes are desired that may be more efficiently and reliably completed.

### BRIEF DESCRIPTION

In one aspect, the disclosure provides a vehicle registration system including a vehicle including a vehicle device configured to receive a vehicle registration data packet including a digital proof of registration, and a vehicle display in communication with the vehicle device and generating, in response to the received digital proof of registration, an electronic proof of registration display at a designated location on the vehicle.

In another aspect, the disclosure provides a vehicle registration system including at least one registration host device configured to generate and communicate a vehicle registration data packet to a vehicle device including a digital proof of registration of a vehicle, the digital proof of registration when activated being automatically and electronically displayed on the vehicle.

In another aspect, the disclosure provides an automated vehicle registration method for a vehicle including a vehicle device and at least one display. The method includes: receiving a communication regarding a vehicle registration event from at least one of the vehicle device and a client device; requesting a vehicle registration from a registration authority in response to the communication; verifying a user account, making a payment and/or verifying a payment made for the registration if registration requirements are satisfied; and receiving a vehicle registration data packet for display of a digital proof of registration on the at least one display.

### BRIEF DESCRIPTION OF THE DRAWINGS

FIG. 1 illustrates an example embodiment of a vehicle registration system.

FIG. 2 is a simplified block diagram of a portion of the system shown in FIG. 1.

FIG. 3 illustrates an example configuration of a user device for the system shown in FIGS. 1 and 2.

FIG. 4 illustrates an example configuration of a server system such as a server system as described herein.

FIG. 5 shows an example configuration of a user account database within a computing device, along with other related computing components, that may be used to create, organize, and monitor a plurality of user data associated with a user.

FIG. 6 is an example of a method performed using the vehicle registration system shown in FIG. 1.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The system and methods described herein are configured to address certain problems and challenges in vehicle registration procurement, compliance and enforcement as further discussed below followed by exemplary systems and methods that overcome such problems and challenges.

Motor vehicles, including but not necessarily limited to passenger vehicles (e.g., cars and trucks), motorcycles, and marine vehicles (boats and watercraft), are required to be registered by their owners, typically with a state or local government registration authority. Provided that the applicable requirements are met a vehicle registration is issued to the owner. Proof of registration is also issued to the owner and is typically required to be displayed in a designated location on the vehicle where it can be viewed and verified from the vehicle exterior. Vehicle registrations are typically valid only for a limited time, but may be renewed if the applicable requirements are met. If so, further proof of registration is issued for display on the vehicle. Vehicle owners that fail to comply with registration requirements are subject to fines and penalty.

Successfully completing the vehicle registration process can be a relatively complex and frequent transaction that presents a number of challenges and inconveniences to the various parties involved. As conventionally undertaken, manually performed steps are required by different parties to complete the registration process, and numerous opportunities for error are presented along the way. As a result, many vehicle owners find the registration process to be inconvenient, if not frustrating for at least the following reasons.

As conventionally practiced, a vehicle owner typically receives a vehicle registration notice by a registration authority in the form of a paper notice, invoice or bill to which the vehicle owner must respond. If the paper notice or bill is not received, however, vehicle owners unfortunately may not realize that action is needed for the vehicle registration. Further, if the paper notice or invoice is mailed to an outdated address, or to the wrong address, the owner may or may not receive it in the timeframe required for action. In other cases, the owner may receive the paper registration notice but fail to timely open it, fail to timely respond to it and/or misplace the vehicle registration paper. Vehicle owners that do not meet required timeframe to register their vehicles are typically subject to penalty such as additional fees. On occasion, a vehicle owner may realize a missed registration deadline only after being pulled over by law enforcement and perhaps receiving a ticket for not having a valid registration.

At the time of payment for the registration, vehicle owners conventionally must appear at a local department of motor vehicles (DMV). At the local DMV the vehicle owner/payer usually must confirm or re-confirm identification information for the vehicle, (e.g., a vehicle identification number (VIN), license plate number, etc.) of the vehicle being registered. It can sometimes be inconvenient for a vehicle owner to provide such information as it often is not readily accessible to the owner at the time of registration. The alphanumeric vehicle identification numbers are lengthy and may also rather easily be incorrectly provided by an owner and/or or incorrectly entered by the registration authority.

Depending on the registration authority, the vehicle owner may have to provide additional information that is required to receive a vehicle registration, including for example only a proof of vehicle insurance, proof of payment of applicable taxes for the vehicle, or proof that the vehicle has recently passed a safety or emissions inspection. Such proof conventionally entails paper documentation from an insurance company, documentation from a taxing authority and documentation from a vehicle safety inspector or emissions inspector. Obtaining such paper proof may also be inconvenient for the vehicle owner to acquire, maintain, and remember to bring to the registration authority.

On occasion, vehicle owners may arrive at the registration authority only to realize that they do not have all the required documentation or that the documentation in hand is somehow insufficient. If so, the owner is typically advised that the registration process cannot be completed and the owner is invited to return at another time with the proper documentation. The documentation requirements may be perceived by some as confusing, onerous, and frustrating to complete. A series of trial and error in person visits is sometimes required to complete the registration process, and registration authority offices are typically open for limited times during the day that present other challenges for busy vehicle owners. Also, as vehicle registrations tend to expire in relatively large groups at the same time, long lines in the registration authority are not uncommon near the expiration date.

Assuming that the vehicle owner proves that entitlement to registration is met via the required documentation, upon payment of a registration fee to the registration authority the vehicle registration is issued. Depending on the registration authority, restricted forms of payment may be required (e.g., cash or check only) that may provide further inconvenience to a vehicle owner. Again, on occasion a vehicle owner not realizing this may have to leave the registration authority and return with the proper form of payment. The owner will typically have to begin again and re-present all the documentation required before making the required payment.

If the vehicle is successfully registered, the vehicle owner conventionally receives a license plate, a sticker or other tangible, physical proof of vehicle registration. Such proof or registration must be affixed to the vehicle in a visible location for possible inspection by law enforcement personnel. Vehicle owners are responsible to properly apply the proof registration in a timely manner by installing the license plates or affixing the sticker in the designated location. A lack of tools or whether conditions may be sometimes prevent this from being immediately accomplished. Vehicle owners have also been known to forget to apply the proof or registration, apply the registration improperly, or sometimes misplace or lose the proof of registration such that another visit to the registration authority is required. Re-presentation of documentation and additional fees may be required.

Depending on registration authority, vehicle registrations may be valid for six months, one year, or two years. Since the registrations expire at the end of the registration period, the vehicle registration may be renewed on a bi-annual basis, a yearly basis, or every other year. Registration for the different time periods may require different documentation and different fees, presenting further mistake and confusion to vehicle owners.

The registration authority conventionally must engage in printing or providing registration notices, registration documents, and physical proof of registration (e.g., license plates or stickers). Sometimes such reminders, bills, documents and proof of registration are mailed to vehicle owners via the postal service. The registration authority must also manage verification of registration and possible returns of the proof of registration that cannot be delivered. Manual verifications (e.g. scanning, entering into a computer) of the proof of verification are sometimes needed to confirm whether the proof of registration is still valid.

To eliminate much of the manual work and mistake-prone steps currently involved in the process of registering vehicles a more automated, connected, and digital system and method is desired.

The present methods and systems described herein facilitate obtaining vehicle registrations, as well as monitoring and compliance with vehicle registration requirements. More specifically, systems and methods described herein for accept vehicle registration acquisition or renewal requests, verify applicable registration requirements, obtain current registration status information, and electronically update and display of proof of registration for a vehicle. Such systems and methods include a digital proof of registration system for a connected vehicle having one or more electronic displays in the vehicle to facilitate an automated digital display of proof of registration. Entitlement to the registration can be electronically verified and confirmed using connected computing devices, and payment may also be accepted electronically accepted and verified. Proof of registration (e.g. license plate or registration ‘sticker’) can be issued in electronic format to the vehicle system and the applicable displays. The electronic registration can have appropriate expiration dates and be displayed and renewed flexibly and remotely by a registration authority. Reminder notices and details may be received by an owner via the vehicle system as well as by other devices and methods. The registration authority may more easily monitor the status of the registrations in real time by communicating with vehicle systems while the vehicle is operating. Vehicle owners can also receive notifications about updated registrations without having to take any action. Manual work and reliance on paper documents and in person visits may be substantially reduced if not eliminated.

In one aspect, the disclosure provides a vehicle registration system including: a vehicle including a vehicle device configured to receive a vehicle registration data packet including a digital proof of registration; and a vehicle display in communication with the vehicle device and generating, in response to the received digital proof of registration, an electronic proof of registration display at a designated location on the vehicle.

In one embodiment, the vehicle device includes a registration display and a driver display, and the vehicle device is configured to display a notice regarding a vehicle registration event on the driver display. The registration display is responsive to display the digital proof or registration when activated by a driver via the driver display.

The vehicle registration system may be in combination with a payment device, the payment device configured to accept a fee payment for the digital proof of registration. The system may also include a payment network.

The system may also include at least one registration host device configured to communicate the vehicle registration data packet to the vehicle device. The at least one host device comprises may be a server system and may also configured to communicate wirelessly with the vehicle device. At least one participant device may be in communication with the least one registration host device. The at least one participant device may be associated with an insurance agency, a tax agency, a safety inspection agency, or a vehicle emissions agency. The at least one registration host device may further be configured to verify a satisfaction of at least one registration requirement for the vehicle. The at least one registration requirement for the vehicle may include one of a vehicle insurance requirement, a vehicle tax requirement, a vehicle safety inspection requirement, and a vehicle emissions requirement. The vehicle registration data packet may be pushed by the at least one registration host device directly to the vehicle device, or the vehicle registration data packet is pulled from the at least one registration host device.

The vehicle device may be configured to automatically provide vehicle information to the at least one registration host device.

In another aspect the disclosure provides a vehicle registration system including at least one registration host device configured to generate and communicate a vehicle registration data packet to a vehicle device including a digital proof of registration of a vehicle, the digital proof of registration when activated being automatically and electronically displayed on the vehicle.

In one embodiment, the at least one registration host device may be a server system. The at least one registration host device may be configured to communicate wirelessly with the vehicle device. The system may also include at least one participant device in communication with the least one registration host device. The at least one participant device may be associated with an insurance agency, a tax agency, a safety inspection agency, or a vehicle emissions agency. The at least one registration host device may also be configured to verify a satisfaction of at least one registration requirement for the vehicle. The at least one registration requirement for the vehicle may include one of a vehicle insurance requirement, a vehicle tax requirement, a vehicle safety inspection requirement, and a vehicle emissions requirement. The vehicle registration data packet may be pushed by the at least one registration host device directly to the vehicle device, or may be pulled from the at least one registration host device.

The vehicle registration system may also include a payment device, the payment device configured to accept a fee payment for the digital proof of registration, and a payment network.

The system may also include a vehicle display in communication with the vehicle device and generating, in response to the digital proof of registration, the electronic proof of registration display at a designated location on the vehicle. The vehicle device may include a registration display and a driver display, and the vehicle device is configured to display a notice regarding a vehicle registration event on the driver display. The registration display is responsive to display the digital proof or registration when activated by a driver via the driver display. The vehicle device is configured to automatically provide vehicle information to the at least one host registration device.

In another aspect, the disclosure provides a vehicle registration system including at least one host device configured to transmit a vehicle registration data packet including a digital proof of registration, a vehicle including a vehicle device receiving the vehicle registration data packet, and a vehicle display in communication with the vehicle device and generating, in response to the digital proof of registration, an electronic proof of registration display at a designated location on the vehicle.

In one embodiment, the at least one host device is a server system. The at least one host device is configured to communicate wirelessly with a vehicle device. The system may further include at least one participant device in communication with the at least one host device. The at least one participant device may be associated with an insurance agency, a tax agency, a safety inspection agency or a vehicle emissions inspection agency. The at least one host device may also be configured to verify a satisfaction of at least one registration requirement for the vehicle, wherein the at least one registration requirement for the vehicle includes one of a vehicle insurance requirement, a vehicle tax requirement, a vehicle safety inspection requirement, and a vehicle emissions requirement.

The system may also include a payment device. The payment device may be a cardholder payment device communicating with a payment network, a digital wallet stored on a vehicle device or a digital wallet stored on another device such as a mobile device of the cardholder or another computer device remote from the vehicle device. When payment is received and the registration requirements are met, the vehicle registration data packet may be pushed by the at least one host device directly to the vehicle device. The vehicle registration data packet may be activated in the vehicle, automatically without input from a user, in response to a predetermined action of a user, or the vehicle registration data packet may be pulled from the at least one host device. The vehicle device may include a registration display and a driver display, and the vehicle device may receive a notice from the at least one host device regarding a vehicle registration event.

In another aspect, the disclosure provides an automated vehicle registration method for a vehicle including a vehicle device and at least one display. The method includes: receiving a communication regarding a vehicle registration event from at least one of the vehicle device and a client device; requesting a vehicle registration from a registration authority in response to the communication; verifying a user account and verifying a payment for the registration if registration requirements are satisfied; and receiving a vehicle registration data packet for display of a digital proof of registration on the at least one display.

In one embodiment, receiving the vehicle registration data packet includes receiving a registration data packet by the vehicle device. The method may further include displaying the digital proof of registration on the at least one display of the vehicle. The method may include verifying that at least one vehicle registration requirement is satisfied such as at least one of a vehicle insurance requirement, a vehicle tax requirement, a vehicle safety inspection requirement, or a vehicle emissions requirement. The method may include generating a communication for receipt by at least one of a vehicle device and a host device regarding a vehicle registration renewal. The method may include accepting vehicle information from the vehicle device.

The technical problems addressed by the vehicle registration system include at least one of: (i) inability to ensure delivery of vehicle registration notices to registered vehicle owners; (ii) inability to avoid human error in vehicle identification; (iii) inability to efficiently process vehicle registration requests; (iv) inability to produce, maintain and store accurate paper documents that prove entitlement to registration; (v) inability to ensure timely display of proof of registrations on registered vehicles, (vi) inability to accept preferred forms of payment for vehicle registration; (vii) inability to track registration status over a population of vehicle owners; and (viii) inability to efficiently change registration and proof of registration formats and procedures.

The methods and systems described herein may be implemented using computer programming or engineering techniques including computer software, firmware, hardware, or any combination or subset thereof, wherein the technical effects may be achieved by (i) electronic self-identification of vehicle information for registration purposes, (ii) electronically confirming entitlement to vehicle registration, including verification of third party registration participant information; (iii) electronically accepting and verifying registration fee payments, (iv) electronically providing registration confirmation and a digital proof of registration to a vehicle device, and (v) electronically displaying the digital proof of registration on a display of the vehicle.

The resulting technical benefits achieved by the vehicle registration system include at least one of: (i) new and improved electronic submission and processing of vehicle registration requests, (ii) improved verification of registration requirements while avoiding human error and mistake, and (iii) a universally applicable electronic display of proof of registration in any format desired or required by multiple different registration authorities.

In one embodiment, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

Embodiments described herein may relate to a transaction card system, such as a credit or debit card payment system using the Mastercard® or Visa® payment network. The Mastercard® payment network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.). In other contemplated embodiments, payments may be facilitated using an ACH Electronic Funds Transfer system, or still other forms of payment as desired.

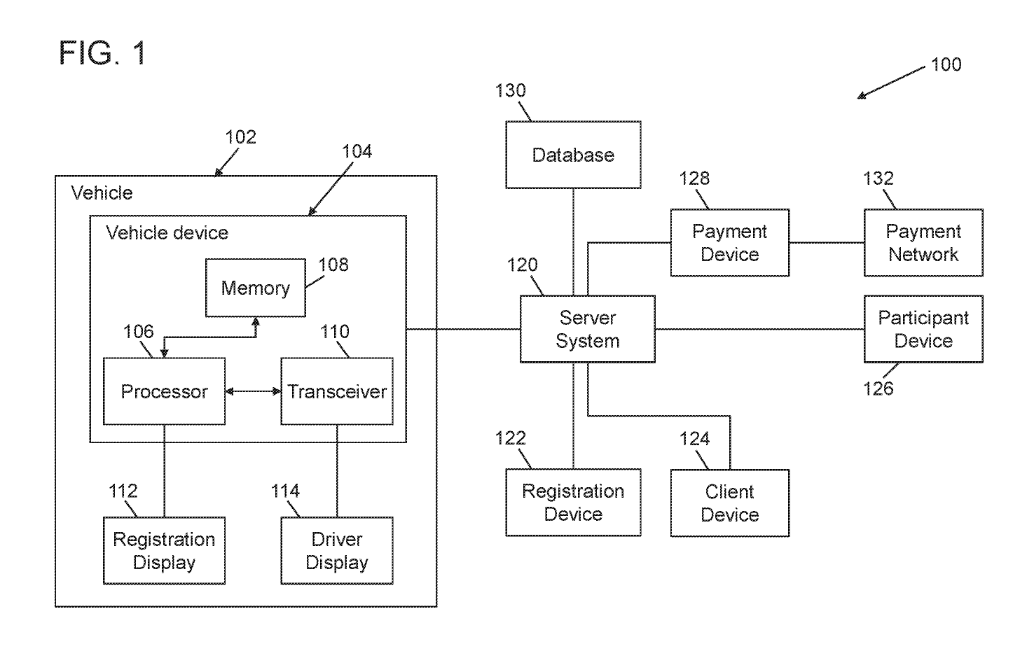

FIG. 1 illustrates an example embodiment of a vehicle registration system 100 for a vehicle 102. The vehicle 102 may in different embodiments be a passenger vehicle (e.g., a car or truck), a motorcycle, or a marine vehicle (e.g., a boat or watercraft). It shall be understood, the system 100 may apply to any other type of vehicle that is subject to registration requirements, and accordingly the present disclosure is not necessarily limited to the specific types of vehicles mentioned above.

The vehicle 102 in the example shown includes a vehicle computer device 104 that in turn includes a processor 106, a memory 108 and a transceiver 110. The vehicle device 102 is therefore capable of bidirectional communication and data exchange with another device according to a known wireless communication protocol. Amongst the data that may be stored and transmitted by the vehicle system is the applicable vehicle identification information needed to register the vehicle, such as, for example only, the vehicle identification number or a license plate number. Also, in contemplated embodiments, payment device data may be stored and transmitted by the vehicle system in the form of a digital wallet, or otherwise communicate payment data with a digital wallet stored on a mobile device. The vehicle 102 further includes a registration display 112 and a driver display 114 in communication with the processor 106 of the vehicle device 102.

The registration display 112 is a digital proof of registration display that electronically displays current proof of registration at a designated location on the vehicle. In one example, the registration display 112 may be a durable digital license plate display screen located in the conventional location of a front or rear license plate on the vehicle being registered. As another example, the registration display 112 may be located at another location such as on the vehicle dashboard where it can be seen through the windshield of the vehicle 100. In some embodiments, more than one registration display 112 can be provided in different locations on the vehicle to display the same or different registration information. By virtue of the registration display 112, proof of registration can be digitally sent the vehicle device 104 over the air in the system 100, received by the vehicle device 104 over the air, and displayed on the registration display 112. Instead of issued license plates or stickers that the owner must affix to the vehicle 102, the vehicle device 104 may automatically cause the proof of registration to be displayed in an instant after it is received via the system 100.

Advantageously, the registration display(s) 112 are able to support various methods of registration requirements in different countries and states. As such, a given vehicle may be registered wherever required without alteration of the vehicle. In some embodiments, the registration display 112 may be provided as an original equipment manufacturer (OEM) feature of the vehicle 102 while in other embodiments the registration display 112 could be an aftermarket device applied to the vehicle 102.

Optionally, the registration display(s) 112, or graphical images generated on the displays, may also include machine readable elements such as scannable QR code or bar codes allowing law enforcement to access additional information as desired that is not apparent from visual inspection of the registration display(s) 112. Also, radio frequency identification (RFID) elements and/or contactless near field communication (NFC) elements may be provided proximate the registration display(s) 112 to allow law enforcement personnel to verify vehicle registration status and obtain additional information. Proof of registration and other information of interest may therefore be made available to law enforcement whether or not the vehicle is running and/or whether or not the electronic registration display(s) 112 are operating. As such, the vehicle 102 may be parked with the engine off and the registration display(s) 112 may be turned off while still allowing law enforcement personnel to assess the registration of the vehicle or obtain further information.

The driver display 114 in one example is located in the interior of the vehicle 102, and among other things, may display registration notices, reminders and prompts to the driver to facilitate the vehicle registration process from inside the vehicle 102. Since in most cases the most common driver is the owner, a relative of the owner, or an acquaintance of the owner, the owner will quickly receive the notice, reminder or prompt such that action may be taken. In contemplated embodiments, the driver display 114 may be a part of an OEM vehicle infotainment system. More than one driver display 114 may be provided in some embodiments, such as one in the instrument cluster and one in the center stack of the front passenger compartment. Registration notices, reminders and prompts to the driver may be automatically displayed, for example, upon vehicle startup on the driver display 114. In another embodiment, the driver display 114 may be provided as an aftermarket device.

In one example, vehicle registration notices, reminders and prompts can be digitally sent in the system 100 directly to the vehicle device 104 over the air, received by the vehicle device 104 over the air, and displayed on the display 114 to ensure that the vehicle owner/driver is made aware of registration events without depending on conventional paper notices sent through the mail. In another embodiment, the vehicle device 104 may be programmed to calculate or otherwise determine registration events at the expiration of applicable time periods and display notices, reminders or prompts to the vehicle owner/driver. The driver display 114 may also display the vehicle identification information to the driver/owner when desired.

In example embodiments, the driver display 114 may be a touch screen display capable of accepting inputs from a driver/owner as well as displaying information to the owner/driver in response to the inputs. Alternatively, the driver display 114 may be coupled to a separate input element as is known in certain types of vehicle infotainment systems. Either way, the owner/driver may conveniently respond to the registration notice, reminder or prompt via the driver display 114 if desired, or such notice, reminder or prompt will be generated again on the driver display 114 until the vehicle registration is completed.

Optionally, the driver display 114, or graphical images generated on the display 114, may also include machine readable elements such as scannable QR code or bar codes allowing a vehicle owner/driver to obtain additional information. Also, radio frequency identification (RFID) elements, Bluetooth communication elements, and/or contactless near field communication (NFC) elements may be provided in the vehicle such that registration notices, reminders or prompts may also be received on another device such as smart phones or tablet device when in communication with the vehicle. In certain embodiments, registration notices, reminders or prompts may be received first by another device and then communicated to the vehicle device 104 by the other device. Also when NFC payment elements are provided, the vehicle owner/driver may submit payment via another device (e.g., a smartphone device) from inside the vehicle.

As the vehicle device 104 and the displays 112, 114 are onboard the vehicle, the needed registration information (e.g., the vehicle identification number) and the proof of registration are always with the vehicle and may be easily retrieved via the displays 112 or 114 and if desired may be electronically sent or transmitted to other devices (e.g., a smartphone or tablet device of the vehicle device or driver) or to the devices described below in the system 100. Conventional reliance on paper documents may therefore be beneficially eliminated. The vehicle device 104 may in some embodiments directly communicate such information to other devices for an automated registration request, approval, and issuance without the owner/driver necessarily needing to personally obtain or transfer the information to the registration authority.

Apart from the vehicle 102, the system 100 may also include a server system 120 that may communicate with the vehicle device 104 as well as a registration host device 122, a client device 124, a participant device 126, an optional payment device 128 and a database 130 as described further below. The server system 122 may communicate with, request, accept and retrieve data and information from each of the devices 122, 124, 126 and 128 and the database 130 as explained below to complete a vehicle registration request that meets all the applicable requirements including payment of the applicable fee. The server system 120 may also receive the digital proof of registration and send it to the vehicle device 104, or alternatively make the digital proof of registration available to the owner/driver who can then direct it to the vehicle device 104.

The registration host device 122 accepts registration options and requirements, and communicates them to the server system 120. The registration host device 120 may receive and store applicable requirements for vehicle registration and may be utilized, for example, by a registration authority representative. While one registration host device 122 is shown in FIG. 1, multiple registration host devices may be provided and utilized by different agents of a registration authority, or by different registration authorities. Each registration authority may be provided with an identifier such that multiple registration authorities may be distinguished by the system 100. The registration host device 122 may also accept registration requests from the server system 120, validate the requests and issue vehicle registration confirmation and digital proof of registration back to the server system 120.

Example registration options may include the various lengths of registration available (e.g., six months, one year, two years) available for different types of vehicles as offered by the registration authority where the vehicle driver/owner resides. Registration options may also include different license plate styles, personalized or vanity plate options, and other items together with their applicable fees.

The registration requirements may include the various conditions that need to be satisfied in the jurisdiction of the registration authority. For example, the conditions may include that the vehicle is actually insured, that applicable sales taxes or other taxes have been paid, that the vehicle meets applicable safety requirements and that the vehicle meets applicable emissions requirements. Considering that the registration options and registration conditions may vary from place to place, the server system 120 may compile the requirements for multiple jurisdictions and store them in the database 130.

The client device 124 in contemplated embodiments accepts registration identification and preferences from the vehicle owner/driver. The registration identification and preferences may include the vehicle owner name and address information, driver's license information, the desired length of registration (e.g., six months, one year, two years), billing preferences (e.g., credit card charge, ebilling, etc.), billing options (e.g., pay on due date versus another date) and personal preferences (e.g., personalized plates or license design preferences). The client device may be, but is not necessarily limited to a personal computer, a laptop or notebook computer, a tablet device or a smartphone device utilized by the vehicle owner/driver.

The participant device 126 accepts registration requirement information from a party other than the vehicle owner and the registration authority. Example participants may include an insurance agent, a taxing authority representative and/or a vehicle safety and emissions inspector. In some instances the vehicle safety and emissions inspector may one and the same, while in other instances one participant may be a vehicle safety inspector and another participant may be a vehicle emission inspector. The safety inspector and the emissions inspector may likewise be at different agencies and different locations. Each respective participant may enter the information regarding vehicle insurance status, taxes paid or taxes due, and the condition of the vehicle as being safe, unsafe or not inspected and the condition of the vehicle as meeting or not meeting applicable emission requirements. At the time of a vehicle registration request, the server system 120 can therefore determine if the conditions are satisfied to obtain a registration, and if not, can communicate a message back to the owner items that certain need to be addressed.

The payment device 128 accepts payment requests and payment processing as registration requests are made and found to meet all the other applicable requirements. The payment system 128 communications with a payment network 132 to process and approve the request for payment in the applicable amount. While a separate payment device 128 is shown in FIG. 1, it is understood that such a separate payment device may be optional when payment information is stored on another device as contemplated above in a digital wallet that can communicate with the payment network 132 without first passing through a dedicated payment device 128.

One or more of the devices 122, 124, 126, 128 shown in FIG. 1 may be a mobile device, such as any mobile device capable of interconnecting to the Internet including a web-based phone, also referred to as smart phone, personal digital assistant (PDA), a tablet, or other web-based connectable equipment. Alternatively, one or more of the devices 122, 124, 126, 128 may be a desktop computer or a laptop computer. Each of the devices 200 may be associated with a user as described below. Each device 122, 124, 126, 128 may be interconnected to the Internet through a variety of interfaces including a network, such as a local area network (LAN), a wireless LAN (WLAN) network, or a wide area network (WAN), dial-in connections, cable modems and special high-speed ISDN lines.

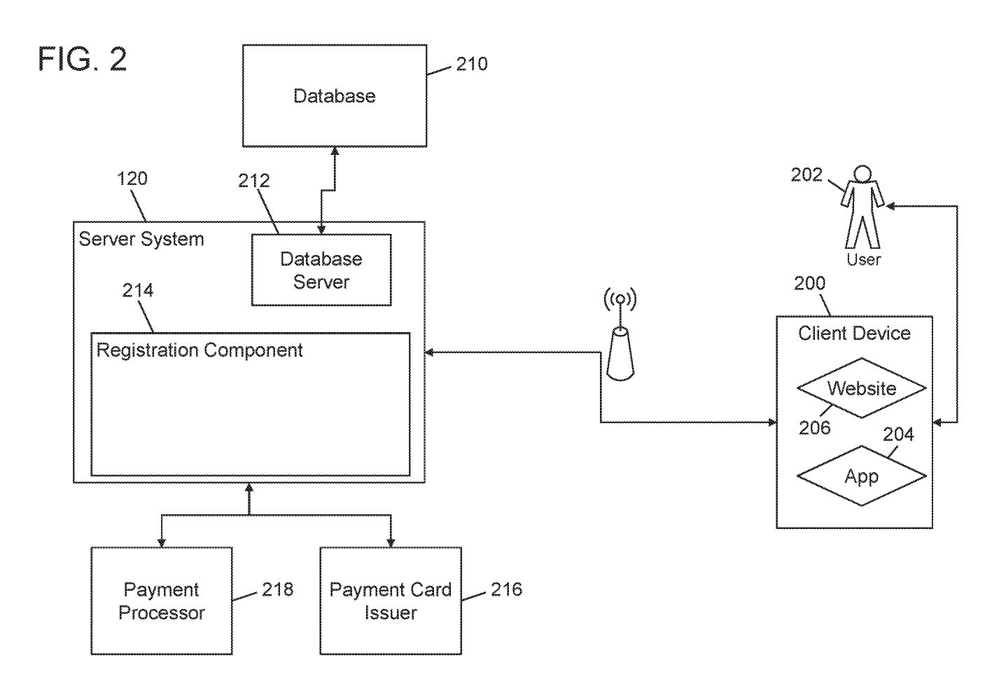

FIG. 2 is a simplified block diagram of a portion of the registration system 100 that includes server system 120. Server system 120 includes a registration computing component 214 for assembling and requesting a vehicle registration request. Registration computing component 214 is in communication with at least one device 200 that may represent the respective devices 122, 124, 126 or 128 described above. The device 200 shown may be associated with a user 202, and the user 202 may represent one of the users of the various devices 122, 124, 126 or 128 described above.

For instance, when the device 200 is the registration host device the user 202 is a registration authority representative or agent. When the device 200 is the client device 124 the user is the vehicle owner or driver. When the device 200 is the participant device 126 the user may be an insurance agent, a taxing authority representative or a vehicle safety inspector. When the device is the payment device 128, the user may be an agent of the payment provider.

In some embodiments, the device 200 includes a software application 204 (i.e., a service app) installed on the device 200. In additional embodiments, the device 200 displays a customized website 206 using a web browser installed on the device 200. As described above, registration computing component 214 receives and options, information, and preferences from a user of the device 200.

In the example embodiment, server system 120 is in communication with a payment processor 218 and/or a payment card issuer 216. Payment processor 218 and/or server system 120 may be associated with an interchange network (not shown). Server system 120 is configured to receive transaction data from payment processor 218.

Server system 120 includes a database server 212 connected to a database 210, which contains information on a variety of matters, as described below in greater detail. In one embodiment, database 210 is centralized and stored on server system 120. In an alternative embodiment, database 210 is stored remotely from server system 120 and may be non-centralized. Database 210 may store transaction data including data relating to merchants, merchant locations, and cardholders. Specifically with respect to the system 100, the database 210 may include a plurality of vehicle registration authorities in different jurisdiction from which vehicle registration requests may be made and accepted including fee payments when the requirements for vehicle registration are met.

In the example embodiment, server system 120 is configured to receive transaction data from payment processor 218. Registration computing component 214 is configured to determine registration status, verify the registration requirements and their status as satisfied or not, coordinate steps to ensure satisfaction of the requirements, assemble and transmit registration requests to the proper registration authority including verification of the requirements, receive confirmation from the registration authority and digital proof of registration to the vehicle device 104, and if desired send digital confirmation and proof of registration to the vehicle device 104. Confirmation can then be displayed to the owner/driver of successful vehicle registration on display 114 and proof of registration can be displayed on the display 112 of the vehicle 102.

Although only one payment card issuer 216, one payment processor 218, one user 202, and one client device 200 are illustrated, it should be understood that the vehicle registration system may include any number of payment card issuers 216, users 202, payment processor 218, and/or devices 200 in communication with server system 120. A plurality of client devices 124 may connect to the system 100 that associate particular vehicle owners or drivers with different payment providers, payment devices and payment networks that may also connect to the system 100.

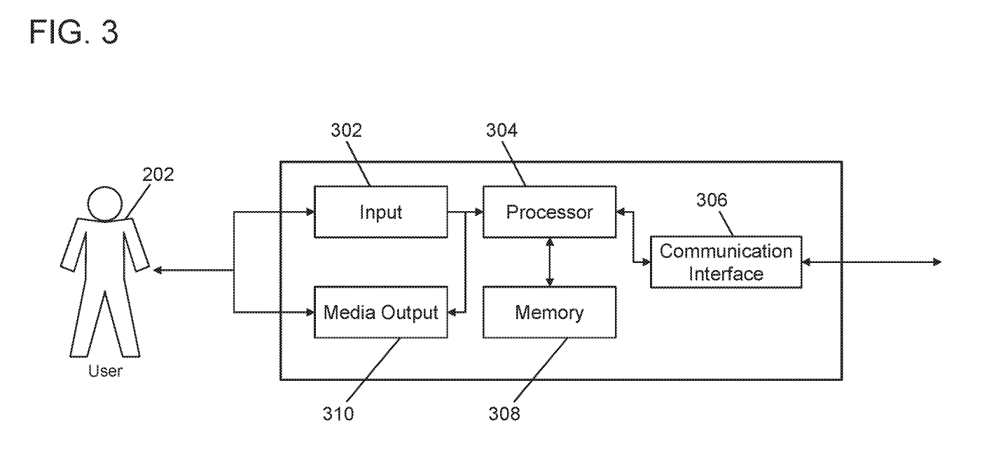

FIG. 3 illustrates an example configuration of a device 200 operated by a user 202, such as any of the users described above. User system 200 may include, but is not limited to, a smart phone, a tablet, and a website. In the example embodiment, client device 200 includes a processor 304 for executing instructions. In some embodiments, executable instructions are stored in a memory area 308. Processor 304 may include one or more processing units, for example, a multi-core configuration. Memory area 308 is any device allowing information such as executable instructions and/or written works to be stored and retrieved. Memory area 308 may include one or more computer readable media.

The device 200 may also include at least one media output component 310 for presenting information to user 202. Media output component 310 is any component capable of conveying information to user 202. In some embodiments, media output component 310 includes an output adapter such as a video adapter and/or an audio adapter. An output adapter is operatively coupled to processor 304 and operatively couplable to an output device such as a display device, a liquid crystal display (LCD), organic light emitting diode (OLED) display, or “electronic ink” display, or an audio output device, a speaker or headphones.

In some embodiments, the device 200 includes an input device 302 for receiving input from user 202. Input device 302 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 310 and input device 302. The device 200 may also include a communication interface 306, which is communicatively couplable to a remote device such as the payment processor. Communication interface 306 may include, for example, a wired or wireless network adapter or a wireless data transceiver for use with a mobile phone network, Global System for Mobile communications (GSM), 3G, 4G, LTE or other mobile data network or Worldwide Interoperability for Microwave Access (WIMAX), or an 802.11 wireless network (WLAN).

Stored in memory area 308 are, for example, computer readable instructions for providing a user interface to user 202 via media output component 310 and, optionally, receiving and processing input from input device 302. A user interface may include, among other possibilities, a web browser and client application. Web browsers enable users, such as user 202, to display and interact with media and other information typically embedded on a web page or a website. An application allows user 202 to interact with a server application from a server system.

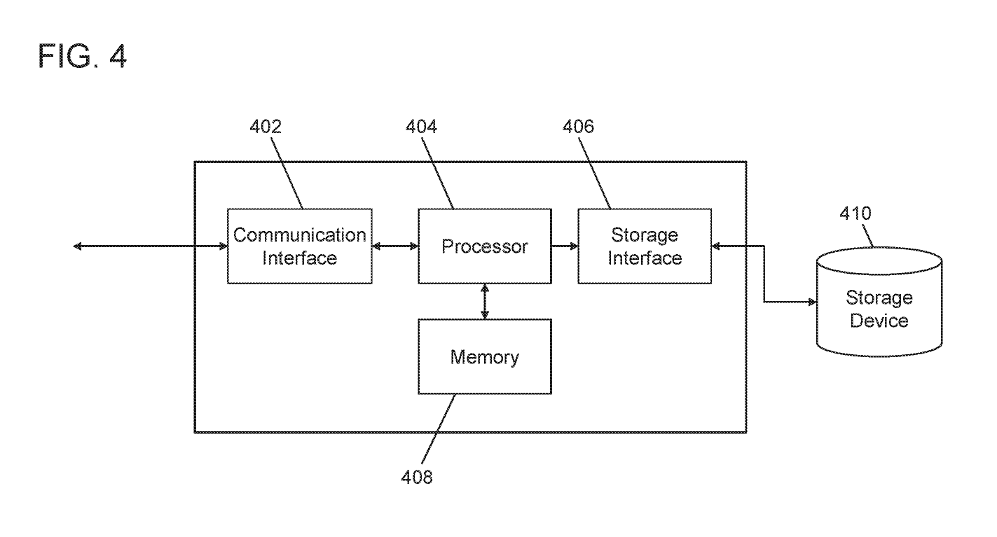

FIG. 4 illustrates an example configuration of a server system 120 such as a server system 120 as described herein. Server system 120 is a database used and managed by at least one of a merchant, such as vehicle registration authority, a payment card issuer, a payment card network, and a third party, used to store user account data, and send, receive, and process signals from various sources. Server system 120 includes a processor 404 for executing instructions. Instructions may be stored in a memory area 408, for example. Processor 404 may include one or more processing units (e.g., in a multi-core configuration) for executing instructions. The instructions may be executed within a variety of different operating systems on the server system 120, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 404 is operatively coupled to a communication interface 402 such that server system 120 is capable of communicating with a remote device such as any of the devices 200 described above or another server system 120. For example, server system 120 may be a server system, wherein communication interface 402 may receive data from payment processor 218.

Processor 404 may also be operatively coupled to a storage device 410. Storage device 410 is any computer-operated hardware suitable for storing and/or retrieving data. In some embodiments, storage device 410 is integrated in server system 120. For example, server system 120 may include one or more hard disk drives as storage device 410. In other embodiments, storage device 410 is external to server system 120 and may be accessed by a plurality of server systems 120. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 406. Storage interface 406 is any component capable of providing processor 404 with access to storage device 410. Storage interface 406 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory area 408 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

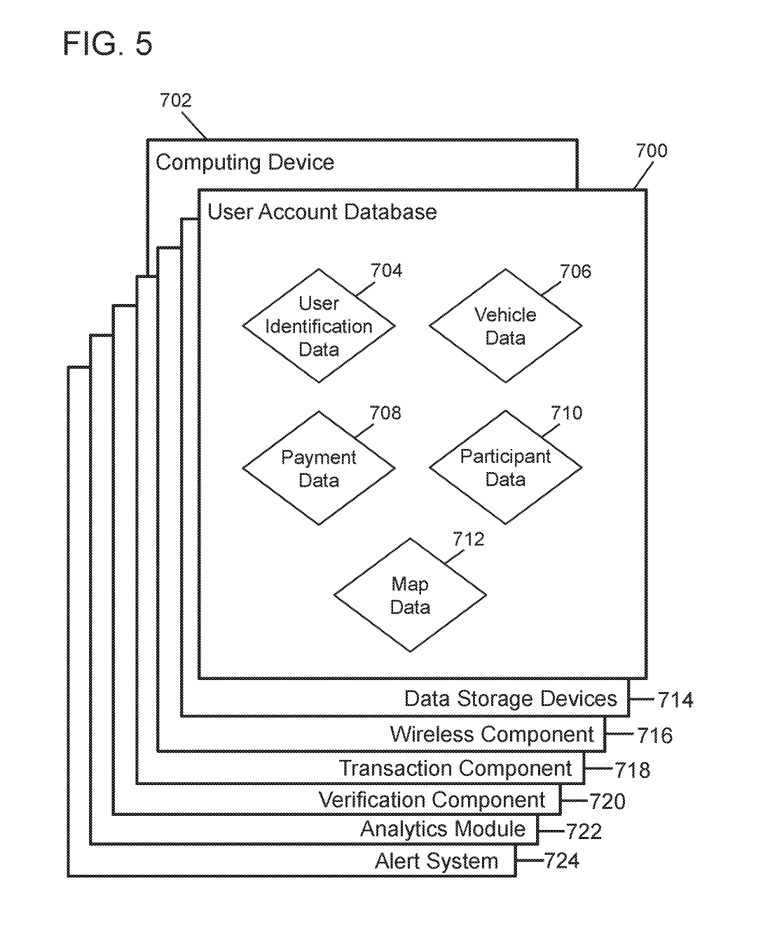

FIG. 5 shows an example configuration of a user account database 700, within a computing device 702, along with other related computing components, that may be used to create, organize, and monitor a plurality of user data associated with a user account. In some embodiments, computing device 702 is the same or similar to server system 122. User account database 700 is coupled to several separate components within computing device 702, which perform specific tasks.

In the example embodiment, database 700 includes user identification data 704, vehicle data 706, payment data 708, registration data 710, and participant data 712. In contemplated embodiments, user identification data 704 includes, but is not limited to, a user name, a user address, and a user phone number. Vehicle data 706 includes data associated with the vehicle to be registered such as, but not limited to, vehicle make, vehicle model, vehicle year, vehicle identification number, and/or vehicle license plate number. Payment data 708 includes, but is not limited to, a card number, a payment history (including receipts), and a billing address. Registration data 710 includes information associated with the requirements to obtain vehicle registration in the applicable jurisdiction. Participant data 712 includes data associated with third party information (e.g., vehicle insurance information, vehicle tax payment information, or vehicle safety inspection information).

Computing device 702 includes the database 700, as well as data storage devices 714. Computing device 702 also includes a wireless component 716 for receiving and analyzing wireless data from, for example, the vehicle device 104. Computing device 702 also includes a transaction component 718 for correlating, for example, payment card transactions with registrations authorities and vehicle owners who are cardholders, and for matching account identifiers. An analytics module 722 is included for analyzing transactions, registration status, success and failure rates of registration requests, time to complete registration and other items of interest. Further included is a verification module 720 that may communicate with vehicle devices 104 to verify current registration and display of proof of registration. Computing device 702 also includes an alert module 724 for transmitting an alert to a cardholder or an issuer, or to any of the participants described so that issues may be timely resolved that would otherwise delay successful vehicle registration.

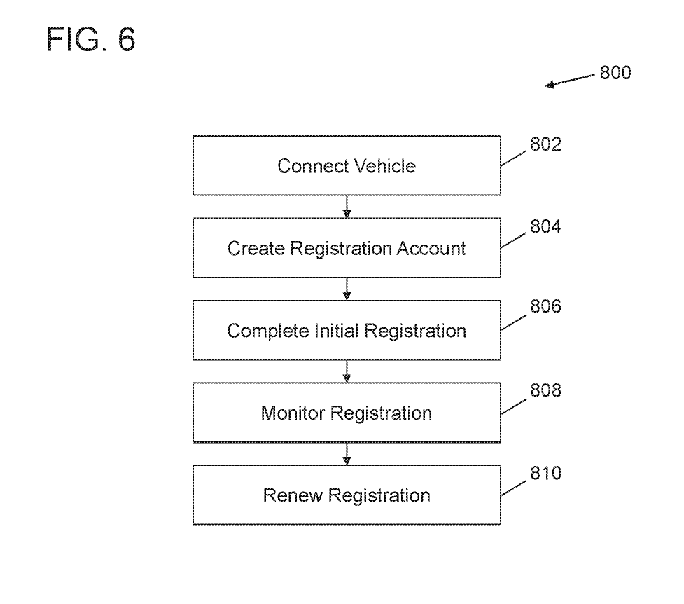

FIG. 6 is an example of a method performed using the vehicle registration system 100 shown in FIG. 1.

At step 802, connection is established between the vehicle 102 and one or more of the devices shown in FIG. 1 such that data and communication can be transmitted back and forth between the vehicle device 104 and applicable ones of the other devices 120, 122, 124, 126 and 128 described. In contemplated embodiments, the vehicle device 104 communicates with the server system 120 that, in turn may communicate with the other devices 122, 124, 126 and 128. It is understood, however, that in other embodiments direct communication may be established between the vehicle device 104 and one or more of the other devices without connecting to the server system 120.

Once the vehicle 102 is connected in the system 100, the vehicle registration display 112 and driver display 114 (FIG. 1) can be connected to the applicable registration authority in the location where vehicle is to be registered. In different examples, this could be accomplished by connecting the vehicle device 104 to an API of the registration authority via the registration host device 122 enabling the registration authority via the device 122 to establish connection to the vehicle device 104, or connecting the registration authority and the vehicle device 104 through the server system 120. That is, the registration authority may communicate with the server system 120 via the registration host device 122, and the server system 120 may communicate with the connected vehicle 102. In certain embodiments, the vehicle device 104 may connect with the server system 120 and also one or more of the devices 122, 124, 126 and 128 to provide a degree of system redundancy. In some cases, a vehicle dealership or vehicle manufacturer may preset the vehicle device 104 to establish the desired connections with the server system 120 and/or one or more of the other devices 122, 124, 126 and 128 so that the connection experience is seamless for the vehicle owner. In other cases, the vehicle connection in the system 100 may be manually established by the vehicle owner at his or her convenience, or manually disconnected as desired.

Connection of the vehicle device 104 and the registration authority allows electronic exchange of the vehicle identification number (VIN) or other desired vehicle information between the vehicle device 104 and one or more of the devices 120, 122, 124, 126 and 128 when the vehicle is first registered, renewed for registration, or re-registered with another registration authority. As such, the vehicle 100 may be self-identifying in the system 100. Human mistake or error in notating, copying, or otherwise transmitting the vehicle information is eliminated by such electronic exchange, and paper documents are not required for vehicle identification purposes. Beneficially, once the vehicle connection in the system 100 is established, it may be maintained even if the vehicle owner changes.

At step 804, a vehicle registration account is created. The creation of the account in one example may be made via the vehicle device 104 or the client device 124 by the vehicle owner to establish an account with the server system 120 or another of the devices 120, 122, 124, 126 and 128. Alternatively, vehicle registration accounts may be created by a vehicle dealership, a registration authority representative, an insurance agent or tax authority agent, a vehicle safety inspection agent, or payment company representative using the devices 120, 122, 124, 126 and 128.

Optionally, in addition to creating an account with the server system 120, an additional account may be created, for example via the vehicle device 104 or the client device 124 to establish an account directly with the registration authority and the registration host device 122. The server system 120 then stores the registration authority account information and utilizes it as necessary to communicate with the registration host device 122. As desired, each account created may include one or vehicle or multiple vehicles, such that an owner of multiple vehicles may manage registrations of all their vehicles in a single account. Likewise, a vehicle may also be added to an existing account, or deleted from an existing account as needs change over time.

The accounts created shall include appropriate information regarding the vehicle owner as well as the car such that law enforcement personnel or others may readily determine ownership and registration of a specific vehicle to a specific person. The vehicle owner may be required to complete Identification and Verification (ID&V) procedures to create an account and be activated as the ‘owner’ and ‘payor’ of for vehicle registration purposes.

Also as part of the account creation, payment preferences are selected by the account owner for a preferred payment method for applicable fees when registering the vehicle or renewing registration of the vehicle. Account options to be selected may include payment via a card on file, one-time payment only, recurring payments, payment via digital payment services such as Masterpass by Mastercard, ebilling, auto account debit, etc. As noted above, payment account creation, options and preferences, etc. may also be facilitated with a digital wallet on any device desired by the vehicle owner/driver.

Account setup may also optionally include additional third party participant information supplied by the account owner that will be needed to register the vehicle. For example, the account owner may supply information for a vehicle insurance policy provider or insurance agent, an insurance policy number, or a scanned copy of a proof of insurance card for the vehicle. The owner may also supply information regarding a vehicle tax identifier, a tax account number, contact information for a taxing authority or a scanned or digital copy of a tax receipt when payment of vehicle taxes is a condition for registration. The owner may also supply information for a vehicle safety inspection, an inspection agency or a scanned copy of an inspection report. Such information may be utilized by the system 100 to confirm and verify entitlement to registration before actually making a request to the registration authority.

After account creation, the account owner may sign in to the vehicle account as needed to update the account over time, check vehicle registration status, and/or manage payment options for any registrations and payments associated with the account. The account owner may conveniently do so via the vehicle device 104 or via a connected mobile interface (app) on another device such as the client device 124. Once the account is created, the vehicle owner may be notified by the system 100 of registration events and may choose to set up fully automatic payments or pay when notified. The registration event may include initial registration (i.e., a registration of a previously unregistered vehicle with the registration authority), an expiration of an existing registration, a deadline to renew registration, or an action relating to a requirement for registration (e.g., insurance requirement, tax requirement, safety inspection requirement.

At step 806, initial registration of the vehicle is completed using information collected from the connected vehicle and the information in the vehicle account. In one embodiment, the server system 120 queries the account information and the vehicle information and assembles a request to the registration authority and sends it to the registration host device 122 in a desired data packet format. The server system 120 and or the registration authority via the registration host device 122, confirms that all details of the registration, inspection, insurance, taxes, etc. are paid and in good standing. Such confirmation may include requesting the third party information from the devices 122 and 126 for independent verification of for comparison to information in the vehicle registration account. If the conditions for registration are met, payment of fees may be submitted to the registration authority using the preferences in the vehicle account and the payment device 128 and network 130 shown in FIG. 1.

If the registration requirements are verified and payment of fees is made, in one example the registration authority may push a registration data package to the vehicle device 104 either indirectly through the server system 120 or directly to the vehicle device 104. Upon receipt of the data package, the vehicle device 104 can digitally display proof of registration, based on the data packet received, in the desired format on the vehicle registration display 112. Confirmation of a successful registration and actual display of the proof of registration can also be presented to the owner via the vehicle driver display 114 or the client device 124.

In another example, if the registration requirements are verified and payment of fees is made the registration authority may notify the account owner, directly or indirectly via the server system 120, of the registration data package but require an action by the owner to complete its receipt and implementation in the vehicle. For example, an activation code may be supplied to the owner to enable the proof of registration display to be output to the display 112 in the vehicle. Such action provides some additional degree of security and notice to the owner of the completed registration before changing the vehicle display 112. The notification may be provided to the account owner in the vehicle on the display 114 or via the client device 122.

In still another example, if the registration requirements are verified and payment of fees is made the account owner can log into the vehicle account and pull the data package whenever desired and supply it to the vehicle device 104 using the client device 122. Such an option may be desirable in a limited connectivity environment wherein the vehicle may have difficulty reliably receiving a push data packet from the registration authority.

Optionally, the registration data package can also include instructions for the vehicle device 104 to update or modify the digital proof of registration display via the display 112 locally without connection to the registration authority or the server system 120. Such instructions may include, for example, time sensitive parameters such as different degree of illumination for night/day conditions, design changes in the display for different seasons or vehicle specific parameters and options. The local instructions may also include notification for expiring registration if for whatever reason data connectivity is lost. As such, notices, prompts or reminders may still be issued locally from the vehicle in an independent manner from the server system 120 or the registration host device 122. System redundancy is therefore made possible to ensure that registration notices, prompts and reminders are timely generated and received by account owners.

At step 808, vehicle registrations are monitored by the system 100 and more specifically by the server system 120 in contemplated embodiments. Based on status of the registrations the server system 120, or the registration authority via the registration host device 122, can send updates to the vehicle display 112 in a specific vehicles whenever necessary. Changes in license plate design displayed on the vehicle display 112 may be made effortlessly by the registration authority, as well as inspection dates and expiration dates in the display 112. Via the vehicle display 114 or client device 124, expiration notices, payments, or third party alerts (e.g., insurance policy expiration or payment, taxes due or payment status, or safety inspection due and status) can be sent to account owners.

While the vehicle remains connected to the system 100, the registration authority can easily monitor the status of registrations across a population of account owners and associated vehicles. Assuming a sufficient rate of connectivity, most if not all registered vehicles in the system 100 would be in contact with the server system 120 and/or the registration authority at any time the vehicle is operating. Registration reports can be easily be generated and compliance issues can be analyzed to optimize the system 100 even further. Account owners may easily be notified in electronic form regarding any change in vehicle registration requirements, registration procedures, or changes in fees. Account owners can also receive notifications about system updates, changed features, and newly added features.

At step 810, a registration renewal is completed. The system 100, and more specifically the server system 120 or the registration authority, issues a reminder that the registration is expiring or that renewal is due. The issued reminder may be received by the account owner via the vehicle display 114 and/or the client device 124. The issued reminder may include optional instructions regarding renewal requirements with sufficient time for the owner to take any necessary actions. Such actions may include a completion of vehicle safety inspection, obtaining current insurance for the vehicle, or paying any taxes due. When such necessary actions are completed the account owner may log into the vehicle account and submit proof of inspection, proof of insurance, or proof of tax payment. The account owner may also submit or update insurance policy information (e.g., insurance provider or insurance policy number, tax payment information (e.g, tax identification number or account number of the taxing authority) etc. so that the system may verify status by contacting the respective third party systems.

In one example, the server system 120 may verify the registration requirements before submitting a request to the registration authority. If entitlement to registration cannot be verified by the server system 120, notice and feedback can be provided back to the account owner so that any deficiencies can be addressed before communication is made to the registration authority.

Once a registration request is made, the registration authority may verify the requirements including payment of applicable fees, and if satisfied the registration authority may electronically accept and grant the request. A data packet such as the one discussed above may be generated electronically including the digital proof of registration for the vehicle display 112. The data packet may be stored on the server system 120 as well as directly or indirectly sent to the vehicle. As with initial registration, the registration authority can push the proof of registration (e.g. digital license plate or registration ‘sticker’) in electronic format to the applicable vehicle displays with automatically or with action taken by the vehicle owner (e.g., an activation code) or may be pulled by the account owner. The electronic proof of registration can have appropriate expiration dates and be displayed and renewed flexibly and remotely by the registration authority and the owner.

As will be appreciated based on the foregoing specification, the above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A vehicle registration system comprising:
a vehicle including a vehicle device configured to receive a vehicle registration data packet including a digital proof of registration; and
a vehicle display in communication with the vehicle device and generating, in response to the received digital proof of registration, an electronic proof of registration display at a designated location on the vehicle.

2. The vehicle registration system according to claim 1, wherein the vehicle device includes a registration display and a driver display, and the vehicle device is configured to display a notice regarding a vehicle registration event on the driver display.

3. The vehicle registration system according to claim 2, wherein the registration display is responsive to display the digital proof or registration when activated by a driver via the driver display.

4. The vehicle registration system according to claim 1, in combination with a payment device, the payment device configured to accept a fee payment for the digital proof of registration.

5. The vehicle registration system according to claim 4, further comprising a payment network.

6. The vehicle registration system according to claim 1, in combination with at least one registration host device configured to communicate the vehicle registration data packet to the vehicle device.

7. The vehicle registration system according to claim 6, wherein the at least one host device comprises a server system.

8. The vehicle registration system according to claim 6, wherein said at least one registration host device is configured to communicate wirelessly with the vehicle device.

9. The vehicle registration system according to claim 6, further comprising at least one participant device in communication with the least one registration host device.

10. The vehicle registration system according to claim 9, wherein said at least one participant device is associated with an insurance agency, a tax agency, a safety inspection agency, or a vehicle emissions agency.

11. The vehicle registration system according to claim 6, wherein the at least one registration host device is further configured to verify a satisfaction of at least one registration requirement for the vehicle.

12. The vehicle registration system according to claim 11, wherein the at least one registration requirement for the vehicle comprises one of a vehicle insurance requirement, a vehicle tax requirement, a vehicle safety inspection requirement, and a vehicle emissions requirement.

13. The vehicle registration system according to claim 6, wherein the vehicle registration data packet is pushed by the at least one registration host device directly to the vehicle device.

14. The vehicle registration system according to claim 6, wherein the vehicle registration data packet is pulled from the at least one registration host device.

15. The vehicle registration system according to claim 1, wherein the vehicle device is configured to automatically provide vehicle information to the at least one registration host device.

16. A vehicle registration system comprising:
at least one registration host device configured to generate and communicate a vehicle registration data packet to a vehicle device including a digital proof of registration of a vehicle, the digital proof of registration when activated being automatically and electronically displayed on the vehicle.

17. The vehicle registration system according to claim 16, wherein the at least one registration host device comprises a server system.

18. The vehicle registration system according to claim 16, wherein said at least one registration host device is configured to communicate wirelessly with the vehicle device.

19. The vehicle registration system according to claim 16, further comprising at least one participant device in communication with the least one registration host device.

20. The vehicle registration system according to claim 19, wherein said at least one participant device is associated with an insurance agency, a tax agency, a safety inspection agency, or a vehicle emissions agency.

21. The vehicle registration system according to claim 16, wherein the at least one registration host device is further configured to verify a satisfaction of at least one registration requirement for the vehicle.

22. The vehicle registration system according to claim 21, wherein the at least one registration requirement for the vehicle comprises one of a vehicle insurance requirement, a vehicle tax requirement, a vehicle safety inspection requirement, and a vehicle emissions requirement.

23. The vehicle registration system according to claim 16, wherein the vehicle registration data packet is pushed by the at least one registration host device directly to the vehicle device.

24. The vehicle registration system according to claim 16, wherein the vehicle registration data packet is pulled from the at least one registration host device.

25. The vehicle registration system according to claim 16, in combination with a payment device, the payment device configured to accept a fee payment for the digital proof of registration.

26. The vehicle registration system according to claim 25, further in combination with a payment network.

27. The vehicle registration system according to claim 16, in combination with a vehicle display in communication with the vehicle device and generating, in response to the digital proof of registration, the electronic proof of registration display at a designated location on the vehicle.

28. The vehicle registration system according to claim 27, wherein the vehicle device includes a registration display and a driver display, and the vehicle device is configured to display a notice regarding a vehicle registration event on the driver display.

29. The vehicle registration system according to claim 28, wherein the registration display is responsive to display the digital proof or registration when activated by a driver via the driver display.

30. The vehicle registration system according to claim 16, in combination with the vehicle device, wherein the vehicle device is configured to automatically provide vehicle information to the at least one host registration device.
